(19) United States
(12) Patent Application Publication
(10) Pub. No.: US 2010/0209058 A1
(43) Pub. Date: Aug. 19, 2010

(54) FIBER OPTIC TELECOMMUNICATIONS SYSTEM

(76) Inventor: Michael J. Ott, Le Sueur, MN (US)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/663,779

(22) PCT Filed: Jun. 18, 2008
(86) PCT No.: PCT/US08/67288

§ 371 Date: Dec. 9, 2009

Related U.S. Application Data
(60) Provisional application No. 60/944,675, filed on Jun. 18, 2007.

(51) Int. Cl. G02B 6/44; G02B 6/00; G02F 1/01

(52) U.S. Cl. 385/101; 385/134; 385/1

(57) ABSTRACT

A communications cable includes two or more optical fibers embedded in a jacket which supports the fibers at a predetermined center-to-center distance. The jacket including at least one reference surface oriented at a predetermined angle to the reference plane. The communications cable may also include one or more electrical conductor. Apparatus is provided for preparing the ends of the optical fibers without use of a ferrule, and for transmitting multiple electrical and/or optical signals over the communications cable.

### CROSS-REFERENCE TO RELATED APPLICATIONS

This application claims the benefit of U.S. Provisional Patent Application 60/944,675, filed Jun. 18, 2007.

### BACKGROUND OF THE INVENTION

This invention relates generally to fiber optics and more particularly to devices and methods for connecting fiber optics in a point-to-point telecommunications system.

Residential and commercial buildings and vehicles use multiple types of communications media such as telephony (hardwired, cellular, and cordless), Ethernet, cable television (TV), wireless broadband, distributed audio and video, security cameras, etc.

In the past such devices and services have been interconnected using dedicated wiring for each service and individual terminal. This is expensive, as it requires individual cable runs for each service, and additional cable runs are difficult to install later. Some buildings incorporate structured wiring in which multiple runs of standardized cable such as Cat 5 or Cat 6 is provided at a number of locations. However, there are limits to how much can be installed, and the multiplexing capabilities of existing wire types are limited.

Optical fibers may be used to carry a multiplicity of signals. However, the vast majority of existing optical fiber termination methods require a precision ferrule in which the individual glass fibers, after their jackets have been removed, are adhered. The ferrule and fiber are both taken through an end-face polishing process. While this is a viable alternative, it consumes much time and materials. There have also been a few designs that used the bare fiber only inside a mechanical housing with alignment done on the bare glass. This is also a viable alternative, but exposes the glass to abrasion (and therefore significant weakening).

### BRIEF SUMMARY OF THE INVENTION

These and other shortcomings of the prior art are addressed by the present invention, which provides a fiber optics cable, connection methods therefor, and telecommunication systems using such cable.

According to one aspect of the invention, a communications cable includes two or more optical fibers embedded in a jacket which supports the fibers at a predetermined center-to-center distance, the jacket including at least one reference surface oriented at a predetermined angle to the reference plane.

According to another aspect of the invention, a communications cable includes: (a) two or more optical fibers embedded in a jacket which supports the optical fibers at a predetermined center-to-center distance such that the fibers define a reference plane; (b) two or more conductors positioned next to the optical fibers, the conductors lying in the reference plane; and (c) a protective cover surrounding the conductors and the optical fibers.

According to another aspect of the invention, a communications system includes: (a) first and second base units, each having: (i) a plurality of first input/output modules, each of the first input/output modules adapted to convert an electrical signal between a predetermined communications format and a modulated electrical signal which is modulated on a selected one of a plurality of carrier frequencies; (ii) a laser emitter; (iii) an optical sensor; and (iv) a controller connected to the laser and the optical sensor, which is operable to receive the modulated electrical signals from all of the input/output modules and drive the laser with the added signals to output a combined optical signal, and to receive a combined optical signal from the optical sensor and to convert it to an electrical signal comprising a plurality of electrical signals modulated at different carrier frequencies; and (c) a communications cable including: (i) a first optical fiber interconnecting the laser of the first base unit and the optical sensor of the second base unit; and (ii) a second optical fiber interconnecting the laser of the second base unit and the optical sensor of the first base unit.

According to another aspect of the invention, an apparatus is provided for connecting two segments of a communication cable which includes two or more side-by-side optical fibers enclosed in a jacket with an elongated cross-sectional shape, each segment having a free end. The apparatus includes: (a) a housing defining: (i) open sockets located at opposite ends of the housing; and (ii) a precision central channel communicating with the sockets, the channel having an elongated cross-sectional shape, and a central portion sized to elastically compress the jacket of the communications cable; and (b) means for securing the communications cable segment in the socket with their free ends meeting inside the precision central channel, such that a portion of each cable is bent within the housing, so as to resiliently bear against the opposing cable segment.

According to another aspect of the invention, a jig is provided for preparing the end of a communications cable which comprises two or more optical fibers embedded in a jacket which supports the optical fibers at a predetermined center-to-center distance such that the fibers define a reference plane. The jig includes: (a) a body having a channel passing therethrough sized to accept the communications cable; and (b) a reference surface oriented at a predetermined non-perpendicular angle relative to a longitudinal axis of the channel; (c) wherein the channel intersects the reference surface.

According to another aspect of the invention, a kit includes: (a) a communications cable, having: (i) two or more optical fibers embedded in a jacket which supports the optical fibers at a predetermined center-to-center distance such that the fibers define a reference plane; (ii) two or more conductors positioned next to the optical fibers, the conductors lying in the reference plane; and (iii) a protective cover surrounding the conductors and the optical fibers; (b) at least one end unit of a first type including means for connecting the conductors to an external electrical device; (c) at least one end unit of a second type comprising a transceiver adapted to send and receive multiplexed communications signals over the conductors; and (d) at least one end unit of a third type adapted to convert an electrical signal between a predetermined communications format and a modulated optical signal for transmission over the optical fibers; (e) wherein each of the types of end units are interchangeably connectable to the communications cable.

### BRIEF DESCRIPTION OF THE DRAWINGS

The invention may be best understood by reference to the following description taken in conjunction with the accompanying drawing figures in which:

FIG. 1 is a side view of a section of communications cable constructed in accordance with an aspect of the present invention;

FIG. 2 is cross-sectional view of the communications cable of FIG. 1;

FIG. 3 is a side view of a section of an alternative communications cable;

FIG. 4 is a cross-sectional view of the communications cable of FIG. 3;

FIG. 5 is a top view of two sections of communications cable prepared for joining;

FIG. 6 is a cross-sectional view of a section of communications cable in a polishing jig;

FIG. 7 is a side view of the polishing jig of FIG. 6;

FIGS. 8A-8D are various perspective views of a cable terminal constructed in accordance with an aspect of the present invention;

FIGS. 9A-9D are various perspective views of a contact for use with the terminal of FIGS. 8A-8D;

FIG. 10 is an exterior perspective view of a connector housing;

FIG. 11 is an interior perspective of the connector housing of FIG. 10;

FIG. 12 is an exterior perspective view of an alignment sleeve for use with the housing of FIG. 10;

FIG. 13 is an interior perspective of the alignment sleeve of FIG. 12;

FIG. 14 is an enlarged perspective view of the alignment sleeve of FIG. 12;

FIG. 15 is an exploded perspective view of a cable, connector, and alignment sleeve;

FIG. 16 is another exploded perspective of a cable, connector, and alignment sleeve;

FIG. 17 is a schematic view of a generalized low-data-rate communications system constructed according to an aspect of the present invention;

FIG. 18 is a schematic view of a generalized high-data rate communications system constructed according to an aspect of the present invention;

FIG. 19 is a schematic view of the functional components of a base unit constructed in accordance with an aspect of the present invention;

FIG. 20 is a schematic front view of a hub cabinet having a plurality of base units installed therein;

FIG. 21 is a front perspective view of the exterior configuration of a base unit constructed according to an aspect of the present invention;

FIG. 22 is a rear perspective view of the base unit of FIG. 21;

FIG. 23 is a front perspective view of the exterior configuration of an alternative base unit; and

FIG. 24 is a rear perspective view of the base unit of FIG. 21.

### DETAILED DESCRIPTION OF THE INVENTION

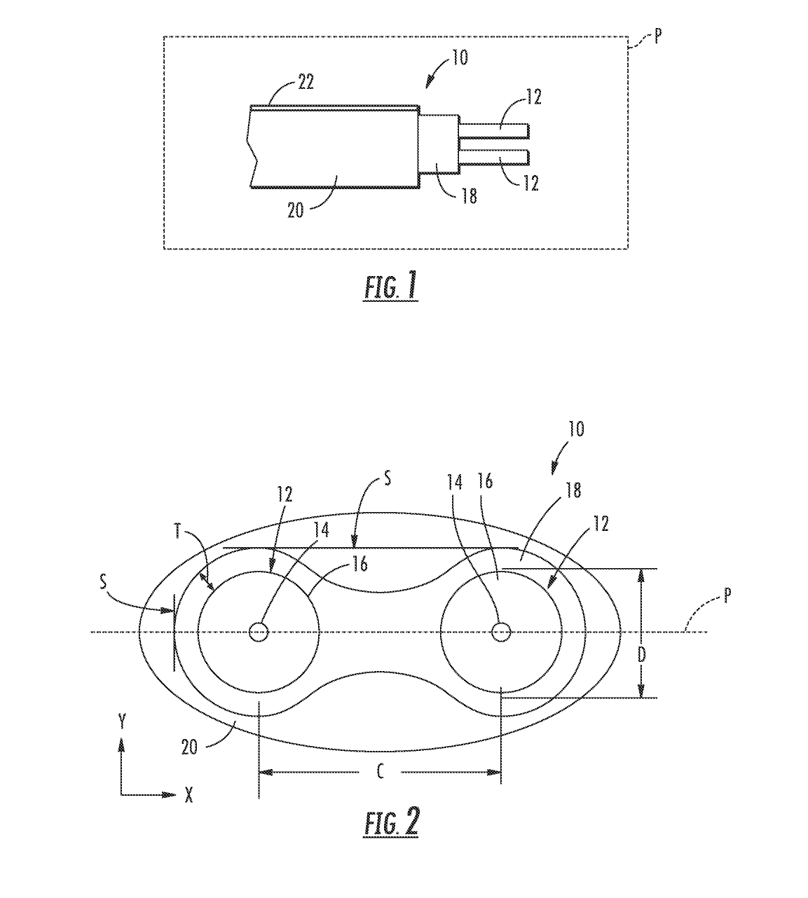

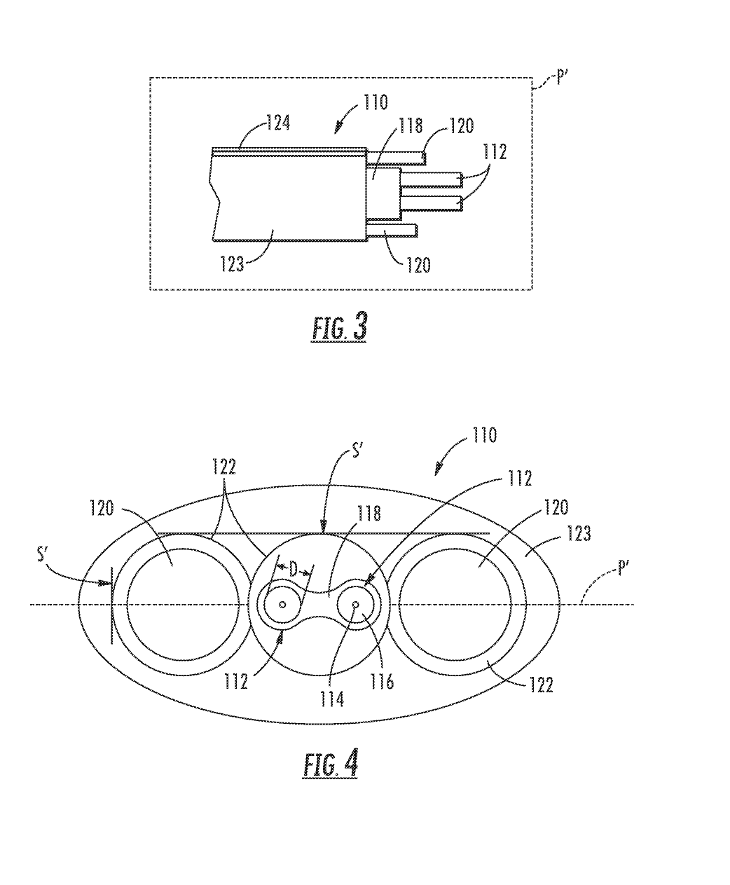

Referring to the drawings wherein identical reference numerals denote the same elements throughout the various views, FIGS. 1 and 2 depict an exemplary section of communications cable 10 constructed according to the present invention. The cable 10 includes a pair of optical fibers 12. In accordance with known practice, each optical fiber 12 has a glass (or polymer) core 14 surrounded by a cladding 16. The relative optical properties of the core 14 and cladding 16 are selected such that a light wave passing through the optical fiber 12 will be confined in the core 14 by total internal reflection. In the illustrated example, the optical fibers 12 are single-mode fibers with a cutoff wavelength of about 780 nm, and have an overall diameter “D” of about 125 μm (125 microns). In some cases the optical fibers 12 might be subject to losses from a “water peak” from the presence of absorbed water or hydrogen bonds. If this is found, it may be reduced or eliminated by known techniques of removing hydrogen and hydrogen bonds from the optical fibers 12, as is done with conventional “low water peak” fibers optimized for other wavelengths.

While the exemplary optical fibers 12 described herein utilize glass core and cladding components optimized for 780 nm single-mode operation, other existing and conventional materials or wavelengths can be used as disclosed in the prior art. These alternatives could include multimode fibers and fibers with other cutoff wavelengths.

A 780 nm single-mode fiber has a much smaller mode field diameter which will likely cause higher losses at joints than with other known fiber types. Current 1310-1550 nm connectivity suffers connection losses averaging something close to 0.2 dB with maximums of around 1.0 dB. 780 nm single-mode fibers have a mode-field cross-sectional area about ⅓rd of conventional fiber, so connection losses will be roughly three times higher, typically about 0.6 dB with maximums of about 3.0 dB. Since the likely applications for the envisioned systems using these optical fibers would not likely involve more than two connections per fiber span nor distances more than about 2 kilometers, system losses should not normally exceed 8 dB and, therefore, should be well within the operating limits of these systems—optical loss budgets should easily exceed 10 dB.

The optical fibers 12 are surrounded by and held in relative position by a jacket 18, which may be made of any material which has a substantially uniform compressibility. An example of a suitable material is UV-curable acrylate polymer. While a pair of optical fibers 12 is shown, a cable may be constructed with any number of optical fibers 12 in a planar array.

The jacket 18 positions the optical fibers 12 in a parallel relationship along the length of the cable 10, at a precise center-to-center distance “C”. In the illustrated example, the optical fibers 12 are positioned about 250 μm (250 microns) apart along a line. It is critical that the distance “C” be uniform for all cables 10 in the system. The example distance C is compatible with known fiber-making machinery. Collectively, the jacket 18 and the enclosed optical fibers 12 define a reference plane “P”. The thickness “T” of the outer layer of the jacket 18 is closely controlled. This precise positioning within the jacket 18 allows for tight, continuous control of dimensional attributes—fiber centering in the coating system and fiber to fiber distance in the same fiber pair. That is, the coordinates (e.g. the X-Y position) of the optical fibers 12 with the jacket 18 is known to a high degree of certainty. The exterior of the jacket 18 is formed in a rectangular, oblong, or similar cross-sectional shape having reference surfaces “S” that are oriented at a predetermined angle to the reference plane P (for example parallel or perpendicular), so that they can be used to align the cable 10 with respect to the reference plane P. This dimensional control, combined with an alignment device and method described below, allows successful mechanical joining of fiber ends without removal of the jacket materials or the use of expensive conventional ferrules.

Optionally, a protective cover 20 of a conventional insulating material such as polyethylene may be placed around the jacket 18. The cover 20, jacket 18, and/or the fiber pair may be provided with a tracer stripe 22 to indicate orientation.

The optical fibers 12 are manufactured using conventional fiber making and coating machinery. The cable 10 may be constructed by providing two separate optical fibers 12 each with its own jacket and then later joining them (e.g. via adhesives, thermal or sonic bonding, or over-coating). Preferably, two optical fibers 12 would be drawn in parallel on the same draw tower, precisely and uniformly coated with a primary UV-cured acrylate plastic and then paired in parallel in a common plane and with an exact spacing (250 microns center-to-center) before being coated with a secondary UV-cured acrylate coating to form a two fiber unit roughly in the shape of a numeral 8. Once the fiber pair is formed and the coating cured, it can be wound onto spools for storage, transport, and payoff for later cabling.

FIGS. 3 and 4 depict an exemplary section of another communications cable 110 which is similar in construction to the communications cable 10. The cable 110 includes a pair of optical fibers 112, identical in construction to the optical fibers 12 described above. The fibers 112 are surrounded by and held in relative position by a jacket 118, which may be made of any material which has a substantially uniform compressibility. An example of a suitable material is UV-curable acrylate polymer.

A pair of conductors 120 are disposed on opposite sides of the jacket 118. Any conductor suitable for carrying communications signals at the associated power levels may be used; in the illustrated example the conductors 120 are 22 or 24 AWG copper wires because these wire gauges match traditional telephony wiring, so many termination alternatives already exist. Collectively, the jacket 118 and the enclosed optical fibers 112 define a reference plane “P′”. A protective cover 122 of a conventional insulating material such as high- or low-density polyethylene is placed around the jacket 118 and the conductors 120. As shown, the jacket 118 and each of the conductors 120 is surrounded by material in a circular cross-section, and then the three separate items are bonded together; however, a single integral cover may be provided. In any case, the overall outside cross-sectional shape of the cover 122 is formed in a rectangle, oblong, or other cross-sectional shape having reference surfaces “S′” that are oriented at a predetermined angle to the reference plane P′ (for example parallel or perpendicular), so that they can be used to align the cable 10 with respect to the reference plane P′.

The optical fibers 112 and jacket 118 may be manufactured as described above for the cable 10. In a subsequent step, the fiber pair and the conductors 120 would be paid off in parallel in a cabling line. In one method, a pressure extruder head equipped with the correct shape forming dies will be used to apply additional thermoplastic or thermoset polymer (e.g. MDPE or HDPE) to complete formation of the cover 122. Preferably, a striping extruder will be operated on the line to place the tracer stripe 124 on the cable 110. The jacket 118 may be clear or white to facilitate printing information thereon if desired. The cover 122 will have the same thickness around the conductors 120 as found on twisted pair within standard Category 3 copper telephony cables. Once the cable 110 is formed, a secondary cover 123 (seen only in FIG. 4) of thermoplastic or thermoset polymer can be applied to provide more protection during installation and/or handing. Between the cover 122 and the secondary cover 123, materials might be included to add tensile strength or prevent water migration down the cable 110 or prevent the cover 122 and secondary cover 123 from sticking to each other. The cover 122 or secondary cover 123 may be provided with a tracer stripe 124 to indicate orientation.

The remainder of this description will focus on the use of the exemplary cable 110 which includes optical fibers 112 as well as conductors 120. However, it will be understood that the principles of connection and routing described below are equally applicable to the cable 10 or other cables which include only optical fibers.

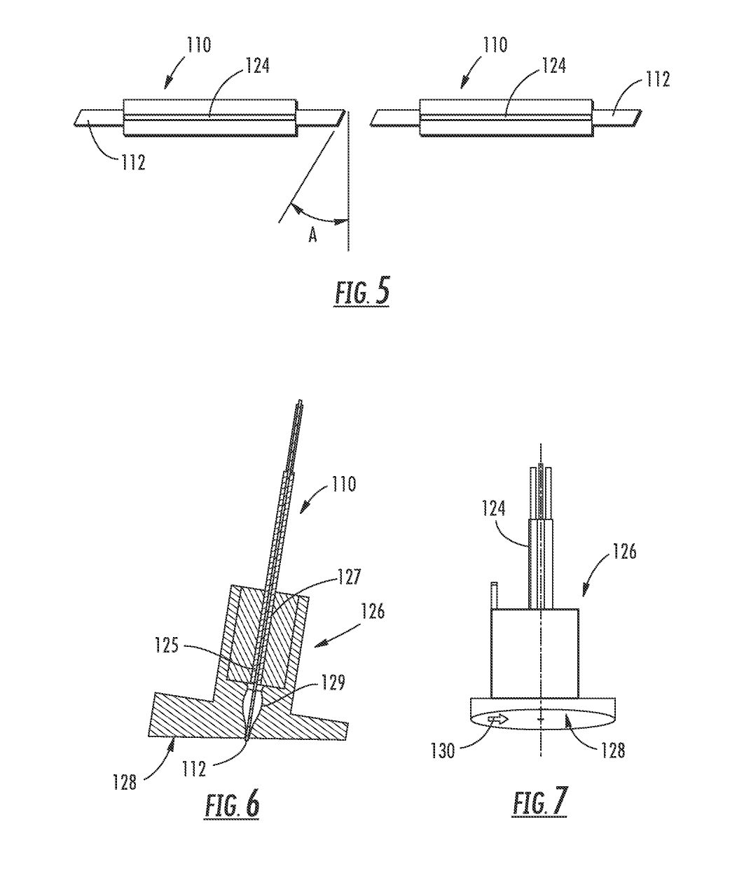

To prepare the cable 110 for connection, the ends of the optical fibers 112 are first ground to an angle “A” as shown in FIG. 5, to avoid harmful and unwanted reflections at fiber end interfaces with other media such as air and other fiber ends. For example, the angle “A” (which is measured from a plane perpendicular to the long axis of the cable 110) may be about 8 degrees. This may be accomplished by stripping away the cover 122, and then placing or clamping the cable 110 with an end of the jacket 118 in a polishing jig 126 as shown in FIGS. 6 and 7. The jig 126 has a rigid body with a channel 127 passing therethrough to accept the cable 110. A shoulder 125 in the channel 127 bears against the cover 122 to restrain the cable 110 at the proper axial position. The reference surface 128 is oriented at the angle A relative to a plane perpendicular to the long axis of the cable 110. Once the cable 110 is inserted, its end may then be worked with an abrasive material against the jig's reference surface 128. The channel 127 includes an enlarged diameter chamber 129 positioned a short distance from the reference surface 128. The permits the optical fibers 112 to slightly buckle or “S” bend when the jig 126 is pressed against a polishing surface.

An example of a suitable abrasive is diamond polishing paper, for example with a grit rating between about 0.5 μm (0.5 micron) and 5.0 μm (5.0 micron) micron, more particularly about 1.0 μm (1.0 micron). Water or other liquid may be used as a lubricant. Regardless of the tooling used, preferably a single-step polish will provide both an 8 degree end and a smooth enough fiber end face to hold end-face flaw contributions to optical loss to less than approximately 0.5 dB.

The polishing jig 126 may include an orientation mark 130 or other indicia. If the tracer stripe 124 is always placed in the polishing jig 126 in the same orientation relative to this mark, then the ends of the cable 110 will automatically be ground correctly for a mating relationship when the tracer stripes 124 are aligned, as shown in FIG. 5. Because of the planar orientation, no special hardware or procedures are required to ensure the correct relative angular alignment of the angled end faces.

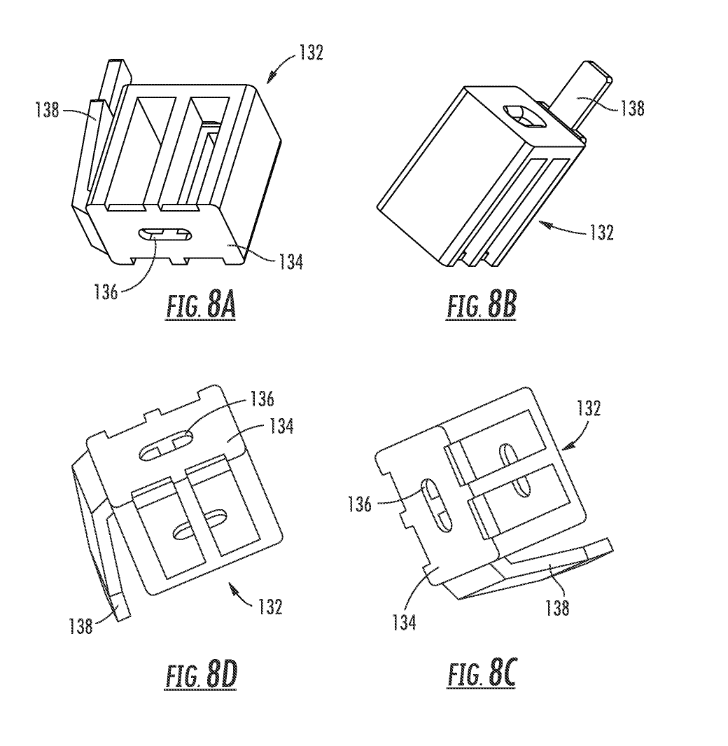

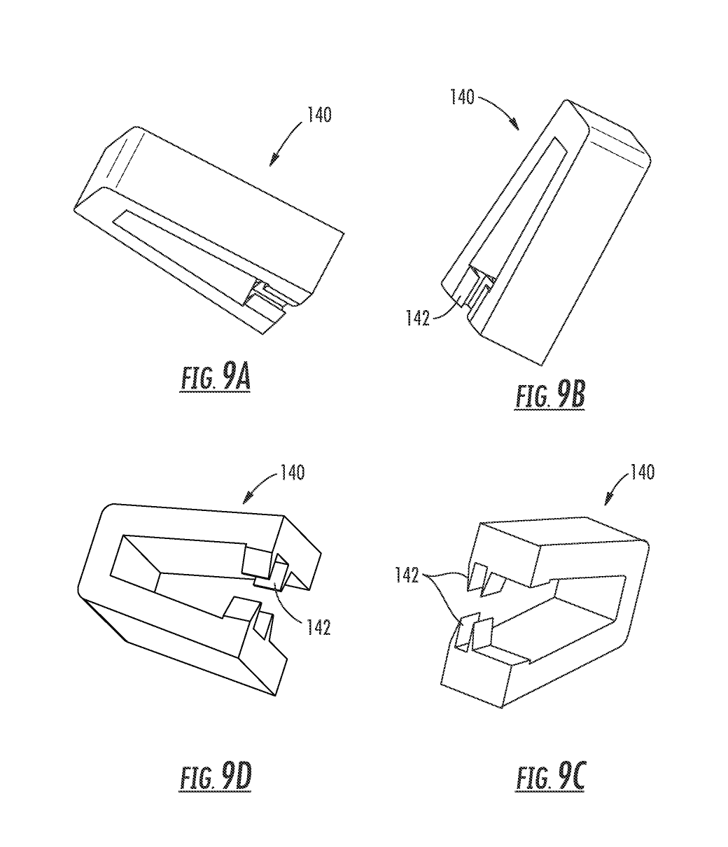

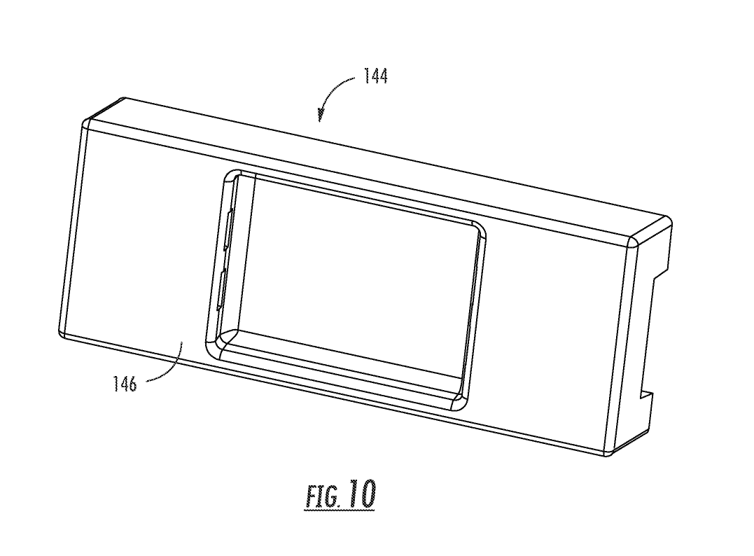

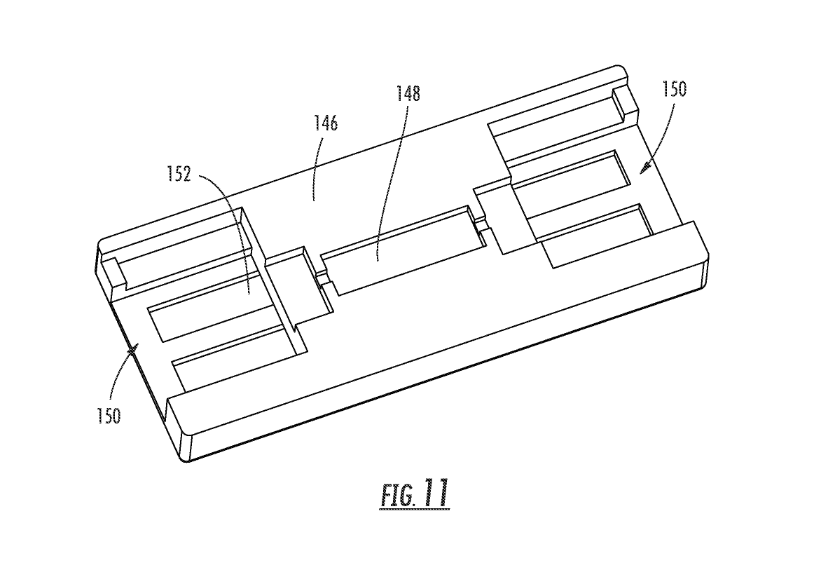

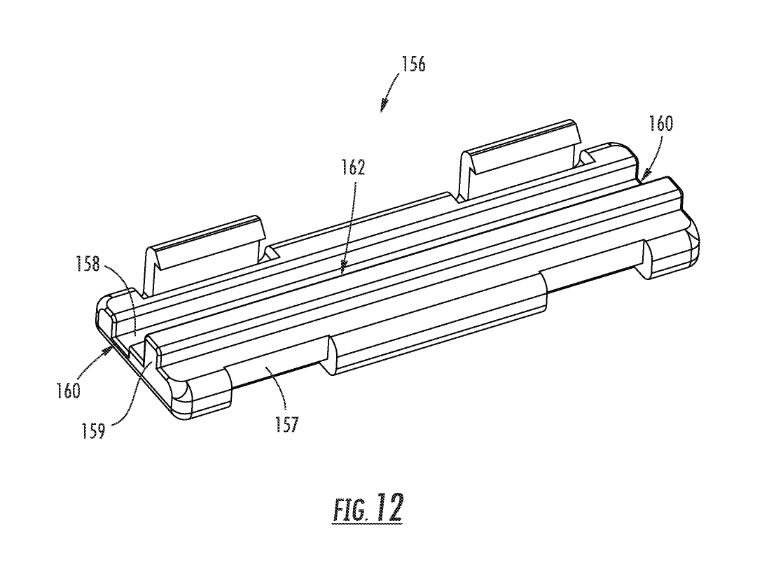

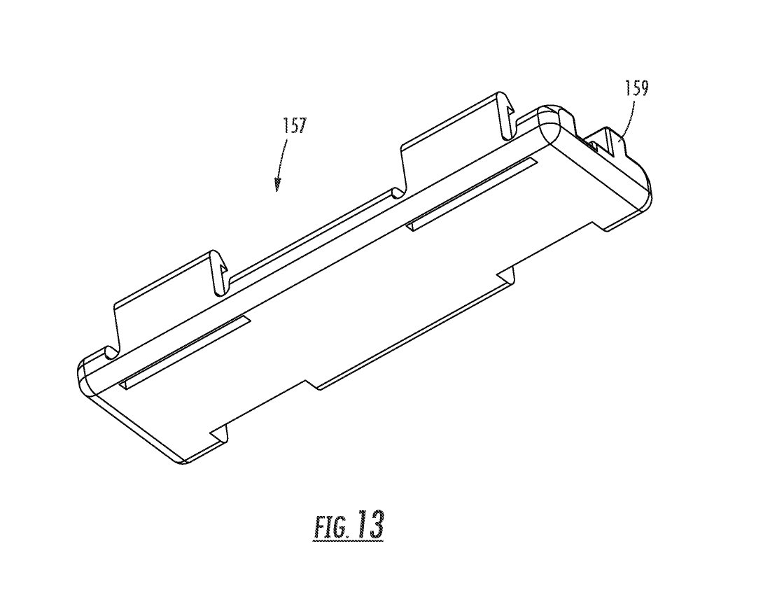

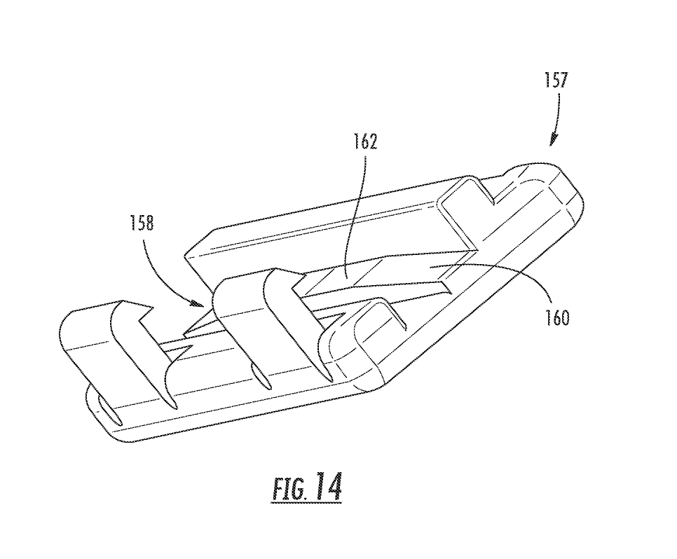

Once the ends of the cable 110 are prepared, there are various means by which it may be connected to another cable or to an optical device. FIG. 8 illustrates an exemplary terminal 132. It may be molded in one piece and is similar in some respects to a conventional RJ-45 terminal. The interior of the terminal 132 is hollow to accept the cable 110 and to allow it to bend. The jacket 118 extends a short distance, for example about 1-2 cm (0.4-0.8 in.) from a front face 134 of the terminal 132 through an opening 136. The terminal 132 includes a spring clip 138 on a short side (top) of its generally rectangular outer surface to ensure that mated pairs of cables 110 are oriented properly with their tracer stripes 124 meeting each other. The terminal 132 carries a conductive contact 140 (see FIG. 15) for each of the conductors 120. The conductors 120 may be electrically connected to the contacts 140 using solder joints or other known methods. Alternatively, the contacts 140 may be of a crimp-on type having insulation-piercing teeth 142, as shown in FIG. 9. A crimping tool would be used to close the contacts 140, displacing the insulation around the conductors 120. Preferably, once the terminal 132 is slid over the cable 110, it would be affixed permanently by crimping, mechanical clamp, spring clip, or other mechanical methods. Soldered connections, adhesives, or thermal or sonic bonding could also be used to secure the terminal 132.

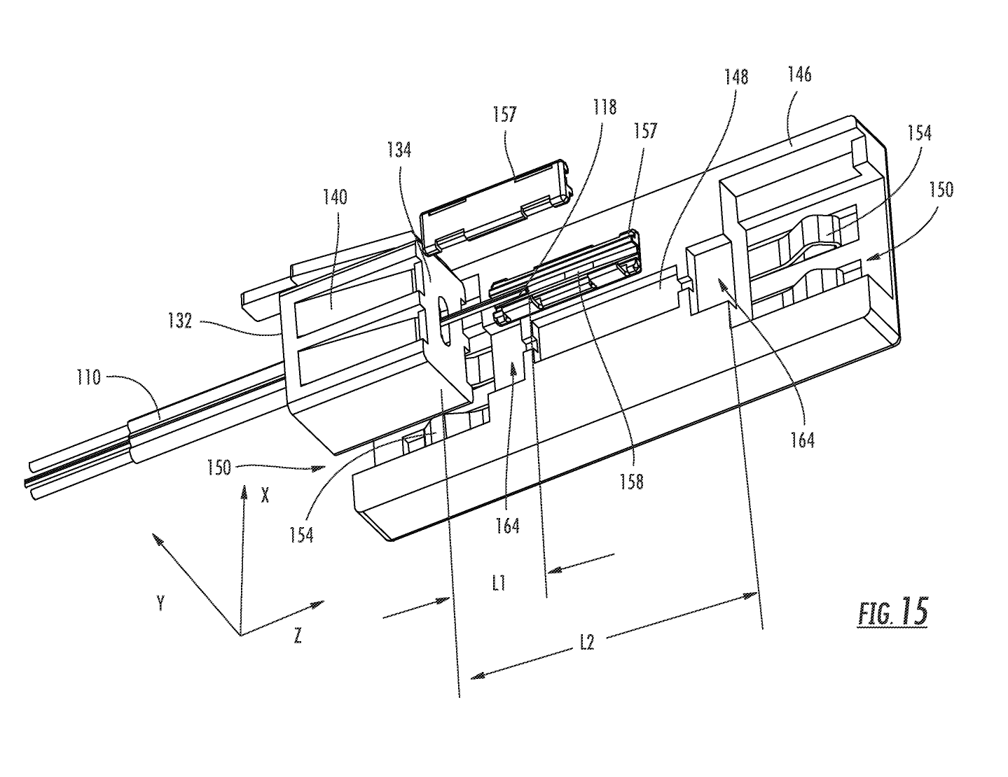

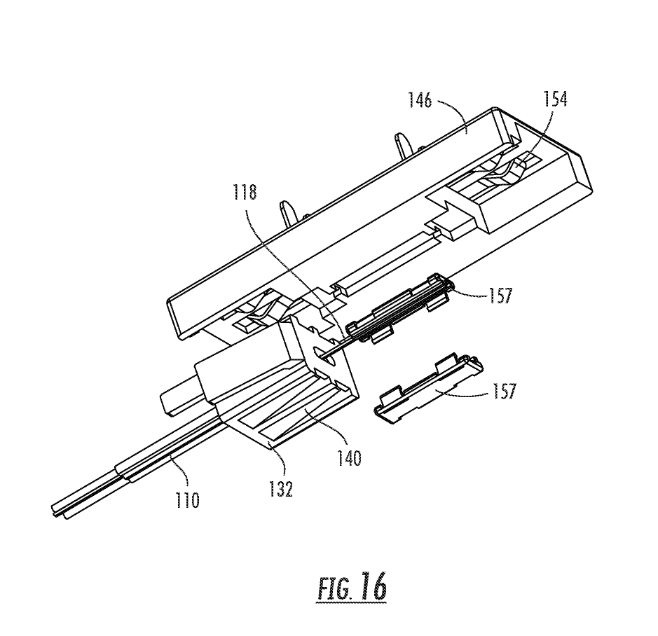

Once the terminal 132 has been affixed to the cable 110, a pair of cables 110 may be joined at a connector 144, one-half of which is shown in FIGS. 10 and 11. The connector includes a housing 146 with a central recess 148 therein. A pair of sockets 150 adapted to receive and lock in the terminals 132 described above are disposed at opposite ends of the housing 146, and a central channel 152 interconnects the sockets 150 and central recess 148. The housing 146 includes conductive contacts 154 (seen in FIG. 15) which interconnect the contacts 140 of the terminals 132. The dimensions of the housing 146 need not be held to close tolerances, and it may be made of a relatively inexpensive material such as molded plastic.

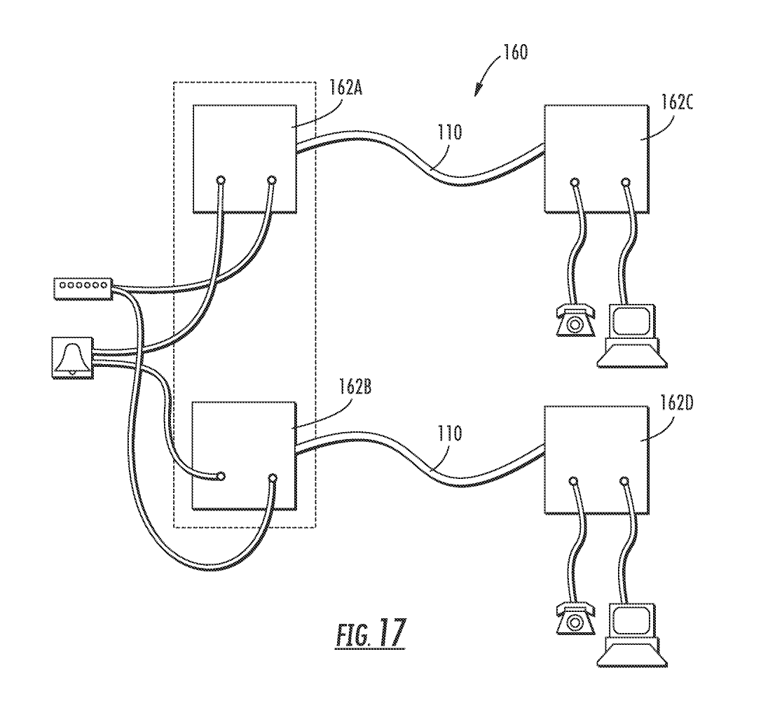

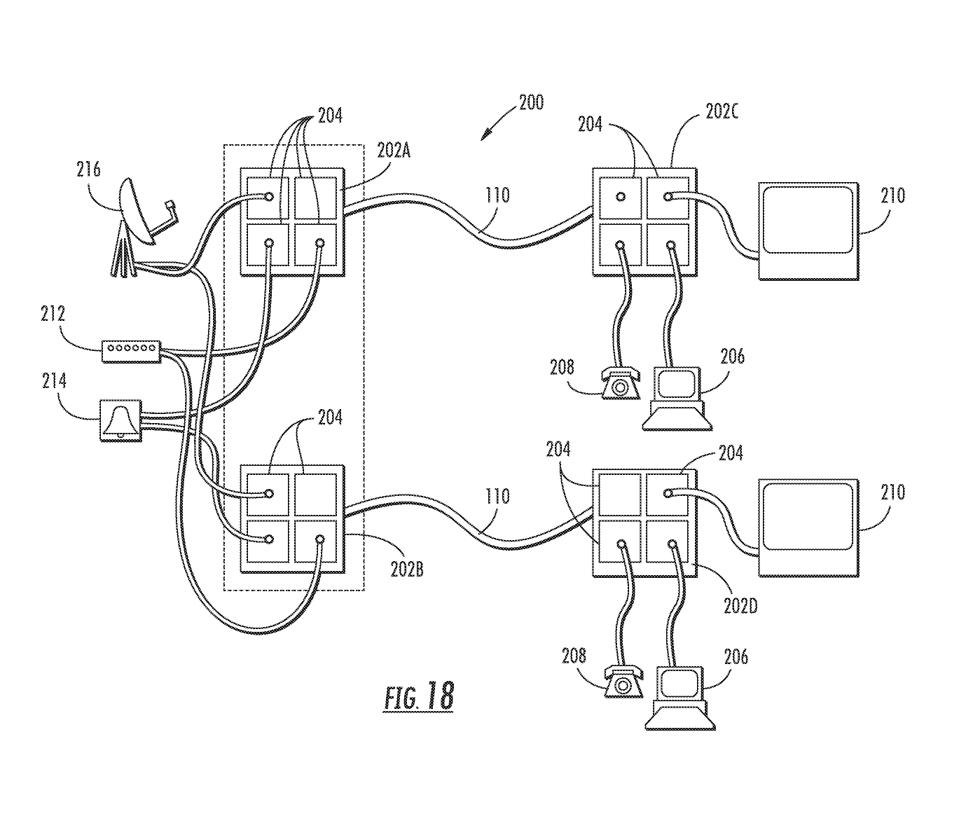

FIGS. 12-14 illustrate an exemplary alignment sleeve 156 which fits into the central recess 148 of the connector 144. The alignment sleeve 156 is constructed in two snap-together halves 157 which are precision molded, formed, or machined. The side walls 159 of the halves 157 are extended to avoid mold parting lines being collocated with the joining locations of the mater pairs of optical fibers 112, as these parting lines would introduce unwanted alignment errors. Collectively the halves 157 define a precision central channel 158, which is generally rectangular in shape in the illustrated example and tapers from a larger opening at its ends 160 to a smaller opening at its central portion 162. The central portion 162 is shaped and dimensioned such that the jacket 118 of the cable 110 will be elastically compressed modestly therein, providing a natural centering of the optical fibers 112. The longer dimension of the central channel cross-section is oriented along the reference plane P′ described above This allows for proper orientation of the angled ends of the mating fiber pairs with consistent fiber end preparation techniques. In other words, there need be no “A” and “B” terminal or fiber preparation.

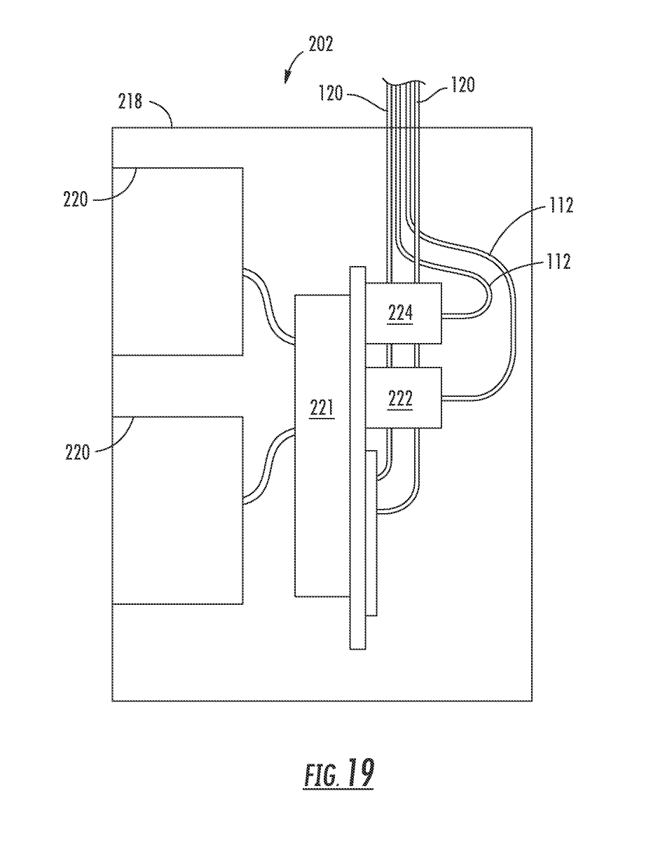

FIGS. 15 and 16 illustrate a cable 110 with a terminal 132 installed in the housing 146. With the terminal 132 snapped into the socket 150, the cable 110 is fixed in a longitudinal or “Z” direction relative to the housing 146. The free end of the jacket 118 with the optical fibers 112 therein extends into the central channel 158 of the alignment sleeve 156. The compression of the jacket 118 noted above creates the proper orientation and location of the optical fiber pair in a lateral or X-Y plane. Only one cable 110 is shown, with the understanding that a second cable 110 would be installed into the central channel 158 from the opposite direction. For each cable 110, the free length “L1” of the jacket 118 from the front face 134 of the terminal 132 is made slightly more than one-half a distance “L2” between the front face 134 and the front face of the opposed terminal (not shown). This creates a nominal interference between the two cables 110. The excess length will cause the jacket 118 with the optical fibers 112 therein to “S” bend slightly outside the alignment sleeve 156 and the jacket 118 and optical fibers 112 themselves will automatically desire to straighten, providing a motive force to keep the mated fiber ends together. An S-bend region 164 to accommodate this bending motion is provided in the housing 146 between the socket 150 and the central recess 148. The length “L1” will be selected relative to “L2” such that sufficient fiber end mating force is provided without excessive “S” bending, which could cause excessive optical losses if present.

Using this combination of terminals 132 and connectors 144, the finished cable 110 may be plugged and unplugged at will, as is the case for a conventional electrical patch cord. It is noted that the central channel 158 and its interaction with the cable 110 is the only critical aspect of this connection technique. While the housing-and-alignment-sleeve configuration described above is easily and inexpensively producible, other configurations may be employed. For example, the connector 144 may be a single molded or cast unit, with the central channel 158 integrally formed or machined therein.

If desired, a modified version of the connector 144 may be used to connect the end of the cable 110 with the terminal 132 attached to an electronic device instead of to another cable 110.

As an alternative, the end of the cable 110 may be prepared as described above without use of a terminal. Once the end is prepared, it would be inserted into a bus rail (not shown) in one slot of a plurality of slots a mechanical clamp would be activated to hold the end in place. This configuration mimics conventional telephony copper wiring technology at terminal panels which often forgo permanent cable end hardware in favor of “punch-down” insulation displacement technology or screw terminal technology in the terminal hardware.

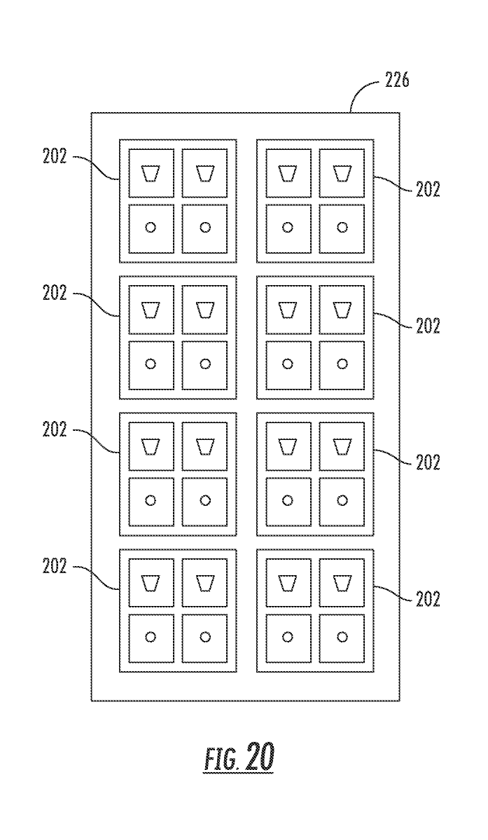

The communications cable 110 and terminal hardware described above may be used with existing terminating hardware to produce a low cost, low performance telecommunications system or “low data rate system”. This may be installed as a first or initial system to be upgraded at a later time. To accomplish this, only the conductors 120 of the communications cable 110 need be connected. An example of such a system is shown at 160 in FIG. 17. At each end of the illustrated communication spans, there is an end unit 162. The end units 162 are interconnected by communications cable 110 as described above, and electrical signals are transferred between the end units 162 via the communications cable 110. One or more of the of the end units 162A and 162B at a central location are designated as “hubs” while the other end units 162C, 162D are designated as remote sites. Voice or other low data rate signals would be transmitted from the hubs 162A, 162B to the remote sites 162C, 162D and back over the conductors 120. Because 22 and 24 AWG copper wires are the standard used by telephony companies for decades, many hardware options for terminating or connecting these wires exist. Today, most involve insulation displacement (ID) technologies.

If desired, slightly more complex units could be installed at both ends of a given communications segment from hub to remote. These units would introduce modulation techniques that would allow multiple carriers to be transmitted in parallel over a single pair of wires. Power at the remote site would come from DC voltage applied to the wires from the hub. −48 VDC would be an excellent choice for power supplies because of decades of widespread use in telephony. In fact, in many instances the −48 VDC could come directly from the service provider since their systems provide −48 VDC to the customer to operate phones.

As an alternative to the system 160 described above or as a subsequent step, the communications cable 110 and terminal hardware described above may be used in combination with electrical-to-optical (E/O) conversion hardware, for example using a vertical cavity surface emitting laser (VSCEL) emitting at 780 nm, due to this configuration's inherent low cost, low power consumption, high modulation frequency, and inherent environmental (thermal) stability, to create a multiplexed point to point communications system, optionally having a central location or hub. A generalized example of such a communications system is shown at 200 in FIG. 17. At each end of the illustrated communication spans, there is a base unit 202A-202D, referred to generally at 200 (described in more detail below) that provides power and electro-optic conversion of inputs and outputs to the span. The base units 202 are interconnected by communications cable 110 as described above, and optical and/or electrical signals are transferred between the base units 202 via the communications cable 110. One or more of the of the base units 202A and 202B at a central location are designated as “hubs” or “hub base units” while the other base units 202C, 202D are designated as remote base units.

Each of these base units 202 will accept at least one input/output module 204. Each module 204 modulates communication inputted thereto onto a standard or proprietary carrier frequency if a carrier does not already exist. The module 204 will add and/or receive its signals to/from the inputs/outputs of the base unit 202. While the number of modules 204, in theory, could extend to infinity, practical applications will likely use about six modules per span to six on each end. Any device which transmits or receives a communications signal may be connected to an appropriate module 204. Non-limiting examples of such devices include telephones, modems, intercoms, Ethernet or other data formats, TV or cable TV, audio, video, security camera signals, and wireless transmitters and receivers. In the illustrated example, a computer 206, a telephone 208, and a TV set 210 are connected to each of the remote base units 202C and 202D, and a data modem 212, telephone service point 214, and video feed 216 are connected to the hub base units 202A and 202B.

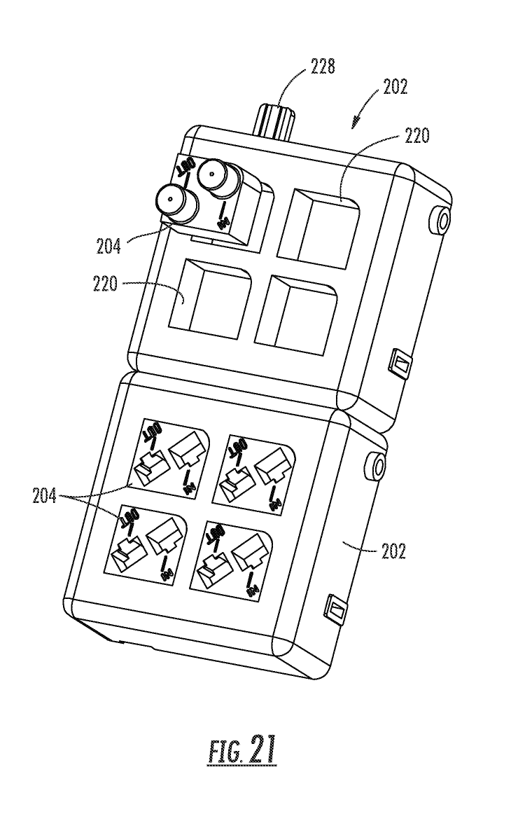

FIG. 19 illustrates the functional components of an exemplary base unit 202. It includes a housing 218 with ports 220 that receive the modules 204. The housing 218 contains a controller 221 (e.g. integrated circuit (IC) or microprocessor), a laser 222, such as a 780 nm-980 nm VCSEL, and a photodiode 224 or other suitable optical sensor. This VCSEL technology is proposed since “natural, basic” VCSEL devices emit at these wavelengths and are widely used in multiple other applications because of the inherent low power requirements, great stability over temperature ranges, high power outputs, and high modulation frequency capability, etc. 630 nm VCSEL technology is also known, has similar properties, and could be an alternative. However, designing a single-mode fiber with even shorter cutoff wavelength will result in even higher connectivity losses, etc. Accordingly, 780 nm-980 nm VCSEL is preferred.

The controller 221 takes electronic input signals and modulates them into a single-mode optical signal via the 780 nm VCSEL. On the same controller 221, incoming optical signals from the opposite end of the communications cable segment will be detected with the photodiode detector 224 and converted into an optical signal placed upon a common output bus. The controller 221 will also include power supply circuitry that will convert incoming −48 VDC into other usable DC voltages, most commonly +5 VDC for use in powering and biasing myriad transistors and other components on the IC plus the IC boards or other components in modules 204 plugged into the base unit 202.

The plug in modules 204 provide circuitry for tuning in and/or stripping off high frequency carriers (where needed for appropriate interface with equipment) to provide electronic signal as outputs to the remote site and modulate incoming signals onto high frequency carriers (where the high frequency carrier does not already exist, e.g. NTSC signals in CATV applications) as inputs to the base unit 202 from transmission to the opposite end of the communications cable segment.

High data rate, multiple signal communications are transmitted by the base unit 202 as follows, with reference to FIG. 18. Suppose a remote site (e.g. at base unit 202C) needs video, 100 Mb/sec Ethernet, and standard telephony. At the hub location, a single base unit 202A would accommodate multiple input/output modules 204 that plug into a common base dedicated to the remote site. Video signals are already modulated onto high frequency carriers of known frequencies so the plug-in module 204 would simply condition the signal slightly, if necessary, and input it to the input of the 780 nm VCSEL. 100 Mb/sec Ethernet from the data modem 212 would be input to a second plug-in module 204. This module would modulate the data stream onto a common WIFI frequency, like 2.4 GHz or another suitable frequency, and input this signal in parallel to the video onto the input of the 780 nm VCSEL. Lastly, a third plug-in module 204 would take the standard telephony voice signal (normally about 6.4 KHz maximum) from the telephone service point 214 and modulate it onto another carrier frequency and then input this signal in parallel to the video and 100 Mb/sec signals on the input of the 780 nm VCSEL. All inputs to the VCSEL are combined into a very complex optical signal at the VCSEL output and coupled to one of the optical fibers 112 of the communications cable 110 for transmission to the opposite end of the communications cable 110.

Almost instantaneously, the optical signal is received at the segment's opposite end base unit 202C. This base unit 202C has the same IC as the base unit 202A on the opposite end. −48 VDC or other appropriate power from the conductors 120 in the communications cable 110 powers the remote base unit 202C. The optical signal is received by a photodiode detector unit which may be optimized for receiving 780 nm light. The photodiode will convert the complex incoming optical signal into a complex electrical signal. This electrical signal is output in parallel to all the plug-in modules 204 in the remote base unit 202. Each plug-in module 204 is designed for its specific telecommunications use. The video plug-in module 204 has a tuning circuit in its IC that will accept only carriers in the known spectrum of NTSC video frequencies. These frequencies are passed through to the TV set 210 via standard coaxial CATV cable. The voice telephony module 204 is tuned to the same carrier frequency of the voice modulator circuit and will pass only the voice signal after stripping off the carrier to return the signal to its base band configuration. Similarly, the 110 Mb/sec Ethernet signal will be acquired by the Ethernet data module and stripped to its base band signal before being sent to the computer 206 or other desired data device.

Transmission in the opposite direction occurs in an identical way, being transmitted over the second optical fiber 112 in the communications cable 110 simultaneously and in parallel with incoming signals from the opposite end on the first optical fiber 112

Dozens or hundreds of signals may be frequency-multiplexed over the optical fibers 112 of the communications cable 110. While the 780 nm-optimized single-mode optical fiber is likely limited to a maximum carrier frequency of about 10 GHz over distances up to about 2 kilometers in the specific source construction described herein, the number of signals transmittable is only limited by the frequency separation within that bandwidth, which is in turn dependent on the ability of the equipment used to modulate and tune the signals to differentiate between carrier frequencies. The frequency spectrum would be allocated by application. In one example, Widely used frequencies would match pre-existing industry standards and/or FCC regulations (for example 2.4 GHz for cordless phones and 802.11 b,g wireless data) to avoid unnecessary modulation/demodulation of signals while remaining frequency spectrum may be allocated as desired. Since the frequencies will be modulated and sent over a the optical fibers 112, negligible signal will be transmitted into the air. Therefore, no FCC regulation or control is required or desired. For the sake of avoiding proprietary solutions and, therefore higher costs to end-users, major suppliers of this equipment may agree upon standards for the frequency usage by module/application. Table 1 below illustrates an example of a group of signals that may be transmitted over the communications cable 110.

TABLE 1

| FREQUENCY RANGE | INTENDED PURPOSE |
|---|---|
| 0.10 KHz to 100 KHz | Base band analog phone line - primary or |
| | single line telephony. |
| 100 KHz to 120 KHz | Second phone line. |
| 120 KHz to 140 KHz | Third phone line. |
| 140 KHz to 160 KHz | Fourth phone line. |
| 160 KHz to 180 KHz | Fifth phone line. |
| 180 KHz to 200 KHz | Sixth phone line. |
| 200 KHz to 550 KHz | Future low data rate applications. |
| 550 KHz to 1.705 MHz | AM radio antenna repeater. |
| 1.705 MHz to 26.90 MHz | Future low/medium data rate applications. |
| 26.90 MHz to 27.30 MHz | CB radio antenna repeater. |
| 27.30 MHz to 54.0 MHz | Future medium data rate applications. |
| 54.0 MHz to 900 MHz | CATV/FM signal repeater. |
| 790 MHz to 810 MHz | Cellular phone signal repeater. |
| 890 MHz to 910 MHz | Cordless phone signal repeater. |
| 1.00 GHz to 1.90 GHz | Future high data rate applications. |
| 1.90 GHz to 2.50 GHz | Cellular Phone/Cordless phone/802.11 b, g |
| | wireless data signal repeater. |
| 2.5 GHz to 5.0 GHz | Future high data rate applications. |
| 5.0 GHz to 6.0 GHz | Cordless phone/802.11a wireless data |
| | signal repeater. |
| 6.0 GHz to 10.0 GHz | Future very high data rate applications. |

The hardware and systems described above may be used in various modifications and combinations depending on budget, space, and performance requirements. Methods and circuitry for creating carriers, tuning signals, and stripping base signals from carriers are well known in the prior art. Some examples are now discussed.

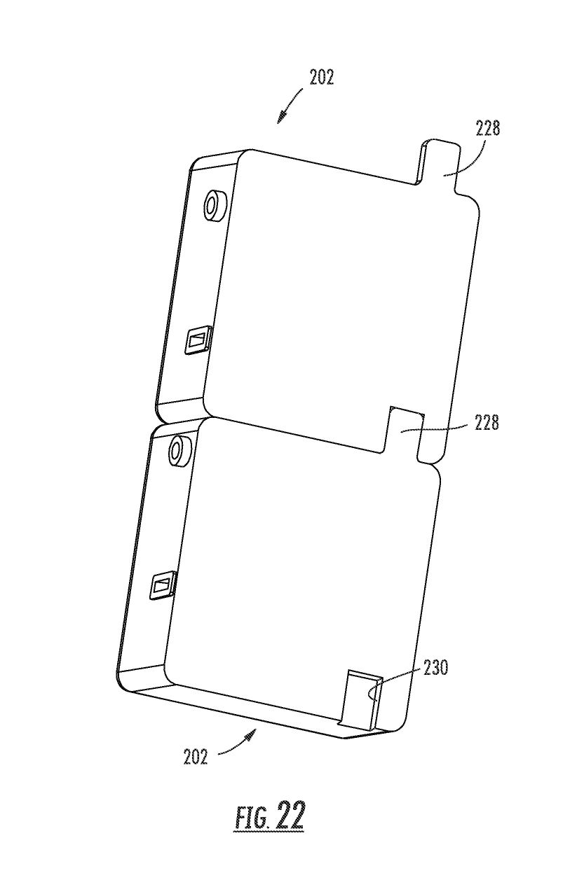

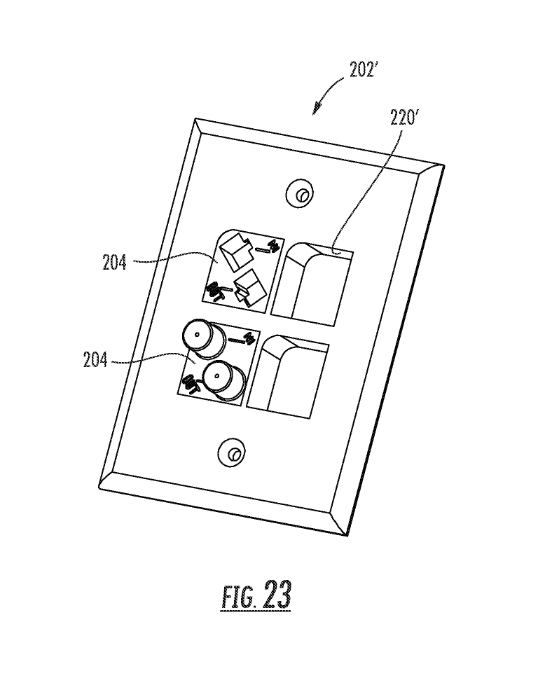

HIGH DATA RATE HUB BASE, RESIDENTIAL: FIG. 20 illustrates a hub cabinet 226 containing a plurality of hub base units 202 at a central location. For residential wiring, most hardware for structured wiring is designed to be accommodated within the 10 cm (4 in.) depth of a typical studded wall. Therefore, base units 202 designed to be housed in a the hub cabinet 226 within a wall would be shallower in depth and larger in width of footprint than in other environments where rack mounting is more likely and common. For this application the base units 202 would be square or rectangular base units that are less than about 5 cm (2 in.) in total depth. The base unit housings may be made from injection molded plastic and then fitted with IC boards and electrical and optic ports during assembly of the housing. FIGS. 21 and 22 illustrate an example of the possible exterior configuration of the base units 202. Hub base units 202 may be powered by various methods. First, the −48 VDC provided by service provider telephony companies can be input into an appropriate insulation displacement (ID) connection. Second, a separate 120 VAC to −48 VDC power supply may be plugged into the base unit 202. Third, base units beyond the first may receive power from adjacent base units via power transfer tabs 228 and associated slots 230.

Physical mounting of hub bases 202 within the hub cabinet 226 may be via DIN rails, keyhole slots, or by magnetic hold-downs. For the magnetic option, a grid of circular pits or pins may be stamped into the cabinet back matching a pattern of corresponding pins or holes on the base mounting surfaces—these features provide protection against slipping of the base unit along the surface of the cabinet back. Each hub base 202 will also have a port for a single communications cable 110. This port will include an alignment mechanism as described above for the optical fibers 112, plus electrical interconnections for the purpose of transferring DC power from the base to the remote data hub via the conductors 120 of the communications cable 110. The base 202 will feature a plurality of input/output ports 220 as described above of a standard footprint which will accept and hold fast the input/output modules 204 needed to transmit and receive the desired signal types at the remote site. As an example, a hub base 202 might include four ports 220 would measure approximately 7.6 cm (3 in.) tall, 7.6 cm (3 in.) wide, and 3.8 cm (1.5 in.) deep. These dimensions should provide sufficient room for the IC boards and interconnection features needed for base unit operation. Each standard module port 220 features sockets for supply, if desired, of −48 VDC, +5 VDC (or other standard alternate DC voltage), and also electrical connections to common signals input bus and signals output bus rails within the base unit 202. Each module port 220 is keyed or shaped so that installation of an input/output module 204 can only be done in a specific orientation.

LOW DATA RATE (E.G. VOICE ONLY) HUB BASE, RESIDENTIAL: For this application, a long rectangular base unit (not shown) would be provided, for example less than about 5 cm (2 in.) in total depth. The base unit housings may be made from injection molded plastic and then fitted with metal (e.g. copper) rails during assembly of the housing. These base units will be simple interconnection rails used to tie the dozens of communications cables 110 together for the purpose of a single line of traditional voice telephony. However, the individual ports will be sufficiently deep to allow protection of the pre-prepared fiber optic pair ends should the installer wish to polish and otherwise prepare the optical end faces for later usage. At one end of the base unit, two standard telephony ports (e.g. RJ-45) plus two sets of insulation displacement connections would be provided. This allows for interconnection of a plurality of low data rate hub bases in larger homes or when the installer has densely populated a smaller home with remote terminal locations.

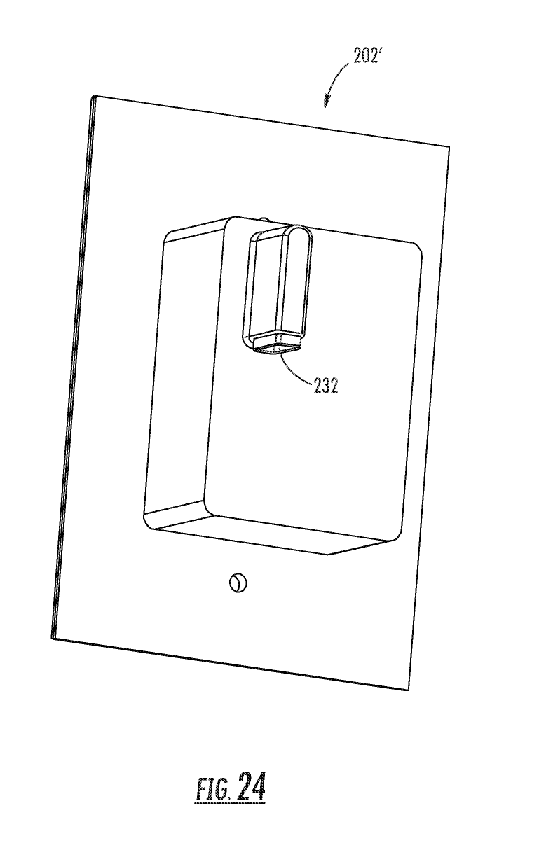

HIGH DATA RATE REMOTE TERMINAL, RESIDENTIAL: For residential wiring, most hardware for remote structured wiring is designed to be accommodated within standard “outlet” wiring boxes approximately 5 cm (2 in.) wide, 7.6 cm (3 in.) tall and 7.6 cm (3 in.) in depth. Therefore, base units designed to be housed in an outlet box within a wall would be shallower in depth and larger in width of footprint than in other environments where rack mounting is more likely and common. An example of such a base unit is shown at 202′ in FIGS. 23 and 24. The base unit housings may be made from injection molded plastic and then fitted with internal components as described above. Remote terminal units may be powered by −48 VDC provided by the conductors 120 of the communications cable 110. Remote base units will have a port 232 for a single communications cable 110 at the back of unit in the portion that will be recessed into the standard outlet box. This port will include an alignment mechanism described above for the fiber pair plus conductor interconnections for the purpose of transferring DC power from the base unit 202′ to the remote data hub via the conductors 120 of the communications cable 110. The remote base unit 202′ will feature a plurality of input/output ports 220′ of the same standard footprint used at the hub base units which will accept and hold fast the input/output modules needed to transmit and receive the desired signal types at the remote site. For example, there could be four ports 220′ per base unit 202′ and the base unit 202′ would measure approximately 7.6 cm (3 in.) tall, 5 cm (2 in.) wide, and 3.8 cm (1.5 in.) deep—not counting the faceplate portion which will measure approximately 10 cm (4 in.) tall, 7.6 cm (3 in.) wide, and 5 mm (0.2 in.) deep. These dimensions should provide sufficient room for the IC boards and interconnection features needed for terminal unit operation. Each standard module port 220′ features sockets for supply, if desired, of −48 VDC, +5 VDC (or other standard alternate DC voltage), and also electrical connections to common signals input bus and signals output bus rails within the remote terminal base unit 202′. Each module port 220′ is keyed so that installation of an input module can only be done in a specific orientation.

LOW DATA RATE (VOICE ONLY) REMOTE TERMINAL, RESIDENTIAL: Standard telephony RJ-45 port faceplates can be used at remote locations by simply disregarding the presence of the optical fibers 112 and terminating the conductors 120 around provided insulation displacement or screw terminals. If desired, a slightly altered faceplate with terminal features identical to the ones used for the communications cable interface on the High Data Rate Remote Terminal described above can be offered. The advantage is that these features would allow the original installer of the system to pre-prepare and protect the ends of the optical portion of the communications cable 110 at the remote locations. This facilitates rapid and simple upgrades in the future at the remote locations.

HIGH DATA RATE HUB BASE, COMMERCIAL WIRING: For commercial wiring, most hardware for structured wiring is designed to be accommodated within the depth of rack mounted hardware. Therefore, base units designed to be housed in a hub cabinet within a rack would be deeper in depth and larger in height of footprint than in residential environments where rack mounting is not likely or common. These might be card or board type base units that are about 15 cm (6 in.) in total depth. Pluralities of tall, deep, narrow base units would be installed into card slots that feature common power rails and optional electronic signal common bus ties. The base unit housings may be made from a combination of injection molded plastic parts fitted to the IC boards and electrical and optic ports during assembly of the base unit. Power for the common supply can come from various sources. First, the −48 VDC provided by service provider telephony companies can be input into an appropriate insulation displacement (ID) connection. Second, a separate 120 VAC to −48 VDC power supply may be plugged into the power rails. Base units will also have a port for a single communications cable connection. This port will include an alignment mechanism as described above for the fiber pair plus interconnections for the conductors 120 for the purpose of transferring DC power from the base to the remote data hub via the conductors 120 of the communications cable 110. The base unit will feature a plurality of input/output ports of a standard footprint for commercial applications which will accept and hold fast the input/output modules 204 as described above needed to transmit and receive the desired signal types at the remote site. For example, six ports 204 could be provided per base and the base unit could measure approximately 10 cm (4 in.) tall, 2.5 cm (1 in.) wide, and 15 cm (6 in.) deep. These dimensions should provide sufficient room for the IC boards and interconnection features needed for base unit operation. Each standard module port 204 features sockets for supply, if desired, of −48 VDC, +5 VDC (or other standard alternate DC voltage), and also electrical connections to common signals input bus and signals output bus rails within the base unit. Each module port is keyed or shaped so that installation of an input module can only be done in a specific orientation.

LOW DATA RATE (VOICE ONLY) HUB BASE, COMMERCIAL: For this application, a long rectangular base unit would be provided that is less than 5 cm (2 in.) in total depth. The base unit housings may be made from injection molded plastic and then fitted with metallic (e.g. copper) rails during assembly of the housing. These base units will be simple interconnection rails used to tie the dozens of communication cables 110 individually to separate conductors coming from the company telephone switch for the purpose of a single line of traditional voice telephony. The individual ports will be sufficiently deep to allow protection of the pre-prepared fiber optic pair ends should the installer wish to polish and otherwise prepare the optical end faces for later usage.

HIGH DATA RATE REMOTE TERMINAL, COMMERCIAL: For commercial wiring, most hardware for remote structured wiring is designed to be accommodated within standard wiring raceways in office furniture. These raceways are long and narrow. Therefore, base units designed to be housed in office furniture wiring raceways would be shallow in depth, short in height, and long in length. For example, rectangular remote terminal units may be (approximately) less than 3.8 cm (1.5 in.) in total depth, less than 3.8 cm (1.5 in.) in height, and 20 cm (8 in.) in length. The base unit housings may be made from injection molded plastic and then fitted with IC boards and a single port for the communications cable 110 during assembly of the housing. Remote terminal units may be powered by −48 VDC will be provided by the conductors 120 of the communications cable 110. Remote units will have a port for a single communications cable connection at the back of unit in the portion that will be recessed into the standard cable raceway. This port will include a communications cable alignment mechanism as described above for the optical fibers 112 plus electrical interconnections for the purpose of transferring DC power from the base to the remote data hub via the conductors 120 of the communications cable 110. The remote terminal will feature a plurality of input/output ports (e.g. ports 204) of the same standard footprint used at the hub base units which will accept and hold fast the input/output modules needed to transmit and receive the desired signal types at the remote site. For example, to six ports per terminal unit may be provided. Each standard module port features sockets for supply, if desired, of −48 VDC, +5 VDC (or other standard alternate DC voltage), and also electrical connections to common signals input bus and signals output bus rails within the remote terminal unit. Each module port is keyed or shaped so that installation of an input module can only be done in a specific orientation.

LOW DATA RATE (VOICE ONLY) REMOTE TERMINAL, COMMERCIAL: Standard commercial telephony RJ-45 port faceplates can be used at remote locations by simply disregarding the presence of the optical portion and terminating the copper wires around the provided ID or screw terminals. If desired, a slightly altered faceplate with terminal features identical to the ones used for the communications cable interface on the High Data Rate Remote Terminal can be offered. The advantage is that these features would allow the original installer of the system to pre-prepare and protect the ends of the optical portion of the communications cable 110 at the remote locations. This facilitates rapid and simple upgrades in the future at the remote locations. For multiple phone lines to the same office, slightly more complex electronics can be used that modulate/demodulate the phone line signals onto different frequency carriers and multiplex/de-multiplex them over the copper pair portion of the communications cable 110 between the hub and remote site.

PARALLEL DATA TRANSMISSION: The communications cable 110 and associated hardware described above may also be used for parallel data transmission in data center applications. In the data center, hundreds of channels, separated by frequency, could be multiplexed over a single fiber pair with minimal concern regarding unequal transit times. In all cases, each module would receive the intended signal by use of a band-pass filter arrangement designed appropriately for the application and/or frequency of interest.

The above-noted cables, connectors, and communication systems have many applications anywhere a point-to-point connection is required. Non-limiting examples of applications include (1) Horizontal wiring from communications closet to desktop in local area networks; (2) Structured wiring in upper scale new construction homes; (3) Remote security camera applications; (4) Industrial control applications; (5) cable TV (CATV) drop cables and associated electro-optic converters in Hybrid Fiber Coax architectures; (6) telephony drop cables and associated electro-optic converters in Fiber to the Curb architectures; (7) parallel data transmission in data center applications; and (8) Automotive control and entertainment systems.

The foregoing has described cables, connectors, and related communication systems. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only.

What is claimed is:

1. A communications cable comprising two or more optical fibers embedded in a jacket which supports the fibers at a predetermined center-to-center distance, the jacket including at least one reference surface oriented at a predetermined angle to the reference plane.

2. The communications cable of claim 1 further comprising a protective cover surrounding the jacket.

3. The communications cable of claim 1 where each of the optical fibers is a single-mode fiber with a cutoff wavelength of about 780 nm.

4. The communications cable of claim 1 wherein the jacket comprises acrylate polymer.

5. A communications cable, comprising:
(a) two or more optical fibers embedded in a jacket which supports the optical fibers at a predetermined center-to-center distance such that the fibers define a reference plane;
(b) two or more conductors positioned next to the optical fibers, the conductors lying in the reference plane; and
(c) a protective cover surrounding the conductors and the optical fibers.

6. The communications cable of claim 5 wherein the protective cover takes the form of:
(a) a first circular cross-sectional shape covering the jacket; and
(b) an additional circular cross-sectional shape covering each of the conductors;
(c) wherein all of the circular cross-sectional shapes are substantially the same diameter and are bonded to each other to define an elongated cross-sectional shape.

7. The communications cable of claim 7 further comprising a secondary protective cover surrounding the jacket.

8. The communications cable of claim 5 where each of the optical fibers is a single-mode fiber with a cutoff wavelength of about 780 nm.

9. The communications cable of claim 5 comprising a plurality of optical fibers arranged in a planar array in the jacket.

10. The communications cable of claim 5 wherein the jacket comprises acrylate polymer.

11. A communications system, comprising:
(a) first and second base units, each comprising:
(i) a plurality of first input/output modules, each of the first input/output modules adapted to convert an electrical signal between a predetermined communications format and a modulated electrical signal which is modulated on a selected one of a plurality of carrier frequencies;
(ii) a laser emitter;
(iii) an optical sensor;
(iv) a controller connected to the laser and the optical sensor, which is operable to receive the modulated electrical signals from all of the input/output modules and drive the laser with the added signals to output a combined optical signal, and to receive a combined optical signal from the optical sensor and to convert it to an electrical signal comprising a plurality of electrical signals modulated at different carrier frequencies; and
(c) a communications cable comprising:
(i) a first optical fiber interconnecting the laser of the first base unit and the optical sensor of the second base unit; and
(ii) a second optical fiber interconnecting the laser of the second base unit and the optical sensor of the first base unit.

12. The communications system of claim 11 wherein each of the optical fibers is single-mode fiber with a cutoff wavelength of about 780 nm.

13. The communications system of claim 11 wherein the communications cable further comprises a pair of conductors interconnecting the base units, the conductor adapted to transmit electrical power between the base units.

14. The communications system of claim 11 wherein:
(a) the first base unit is located at a first location in a building structure; and
(b) a plurality of the second base units are located within the building structure remote from the first base unit; and
(c) the first base unit is interconnected with each of the second base units in a point-to-point configuration.

15. An apparatus for connecting two segments of a communication cable which includes two or more side-by-side optical fibers enclosed in a jacket with an elongated cross-sectional shape, each segment having a free end, the apparatus comprising:
(a) a housing defining:
(i) open sockets located at opposite ends of the housing; and
(ii) a precision central channel communicating with the sockets, the channel having an elongated cross-sectional shape, and a central portion sized to elastically compress the jacket of the communications cable; and
(b) means for securing the communications cable segment in the socket with their free ends meeting inside the precision central channel, such that a portion of each cable is bent within the housing, so as to resiliently bear against the opposing cable segment.

16. The apparatus of claim 15 wherein:
(a) the housing defines a central recess disposed between the sockets; and
(b) the precision central channel is defined by an alignment sleeve which is received in the central recess.

17. The apparatus of claim 15 further comprising a terminal which:
(a) is adapted to be secured to the cable segment such that the free end of the cable segment protrudes therefrom, and
(b) which includes means for releasable engagement with the socket.

18. The apparatus of claim 17 wherein:
(a) the housing has at least one conductive member extending therethrough which terminates in contacts exposed in the sockets; and
(b) the terminal includes a contact which is adapted to mate with a corresponding contact in the socket, and to be secured to a conductor which forms part of the communications cable segment.

19. A jig for preparing the end of a communications cable which comprises two or more optical fibers embedded in a jacket which supports the optical fibers at a predetermined center-to-center distance such that the fibers define a reference plane, the jig comprising:
(a) a body having a channel passing therethrough sized to accept the communications cable; and
(b) a reference surface oriented at a predetermined non-perpendicular angle relative to a longitudinal axis of the channel;
(c) wherein the channel intersects the reference surface.

20. The jig of claim 19 further comprising an enlarged chamber positioned adjacent the reference surface to as to accommodate bending of the optical fibers.

21. The jig of claim 19 further comprising an orientation mark disposed on the body which indicates the proper orientation of the communications cable within the jig.

22. The jig of claim 19 wherein the predetermined angle is about 8 degrees from a plane perpendicular to the longitudinal axis of the channel.

23. The jig of claim 19 wherein the channel includes a shoulder adapted to restrain the cable at a predetermined axial position relative to the body.

24. A kit comprising:
(a) a communications cable, comprising:
(i) two or more optical fibers embedded in a jacket which supports the optical fibers at a predetermined center-to-center distance such that the fibers define a reference plane;
(ii) two or more conductors positioned next to the optical fibers, the conductors lying in the reference plane; and
(iii) a protective cover surrounding the conductors and the optical fibers;
(b) at least one end unit of a first type including means for connecting the conductors to an external electrical device;
(c) at least one end unit of a second type comprising a transceiver adapted to send and receive multiplexed communications signals over the conductors; and
(d) at least one end unit of a third type adapted to convert an electrical signal between a predetermined communications format and a modulated optical signal for transmission over the optical fibers;
(e) wherein each of the types of end units are interchangeably connectable to the communications cable.
